(19) United States
(12) Patent Application Publication
(10) Pub. No.: US 2026/0036558 A1
(43) Pub. Date: Feb. 5, 2026

(54) Method and System for Processing Chromatogram Data

(71) Applicant: SHIMADZU CORPORATION, Kyoto-shi (JP)

(72) Inventors: Yuichiro FUJITA, Kyoto-shi (JP); Akira NISHIO, Kyoto-shi (JP); Davide Giovanni VECCHIETTI, Kyoto-shi (JP); Toshinobu YANAGISAWA, Kyoto-shi (JP)

(21) Appl. No.: 19/289,599

(22) Filed: Aug. 4, 2025

(30) Foreign Application Priority Data
Aug. 2, 2024 (JP) 2024-128283

(51) Int. Cl. G01N 30/86

(52) U.S. Cl. CPC G01N 30/8693; G01N 30/8634; G01N 30/8637; G01N 30/8651; G01N 30/8668

(57) ABSTRACT

First data includes chromatogram data consisting of the retention time and the signal intensity of transmitted/absorbed light acquired. Second data is three-dimensional data consisting of the retention time, mass-to-charge ratio and signal intensity. A first retention-time range where a target peak is present and the waveform of the target peak are determined in a chromatogram created from the first data. The number of component peaks within a second retention-time range which corresponds to the first retention-time range in a three-dimensional graph created from the second data is acquired as a measured component-peak number. Model functions whose number equals the measured component-peak number are created, each function involving a peak-width variable representing the width of a component peak. The model functions are gradually modified by adjusting their peak-width variables until the degree of similarity in waveform between the target peak and a model peak expressed by those functions exceeds a threshold.

### TECHNICAL FIELD

The present invention relates to a method and system for processing chromatogram data.

### BACKGROUND ART

A liquid chromatograph (LC) which uses a photodiode array (PDA) detector or similar multichannel detector can obtain three-dimensional data consisting of time, wavelength and signal intensity (absorbance) by successively acquiring absorption spectra of a sample eluted from an analytical column.

In a common procedure for performing the quantitative determination of a component in a sample by means of a liquid chromatograph, a chromatogram is created by using a wavelength at which the component shows the highest absorbance, and the quantity of the component is determined from an area value of the peak corresponding to the component appearing on the chromatogram. However, in some cases, a component (impurity) which is not the target component may be contained in the sample, and the peak of that impurity may overlap the peak of the target component, forming a single peak. In such a case, for the determination of the peak-area value of the target peak, it is necessary to separate the peak of the impurity from the peak of the target peak on which the peak of the impurity is superposed.

As for the method by which a peak formed by a plurality of peaks originating from a plurality of components is separated into peaks corresponding to the individual components (“component peaks”), a method which employs a model function that expresses the peak waveform, such as an EMG (Exponential Modified Gaussian) function or BEMG (Bidirectional Exponential Modified Gaussian) function, has been commonly known (see Patent Literature 1). In this method, a peak to be analyzed (“target peak”) is extracted from a chromatogram. On the assumption that the number of component peaks included in the target peak is one, a peak waveform is generated by the model function and the process of fitting this peak waveform to the target peak is performed. In this fitting process, the variables in the model function are initially set to random numbers (or the like) and each variable is subsequently varied to determine a model function which expresses a peak waveform that most closely approximates to the target peak. An index for evaluating the degree to which the peak waveform expressed by the model function approximates to the target peak (“degree of similarity”) is calculated. If the value of this degree of similarity does not fall within a predetermined range, the assumed number of component peaks is increased by one. Then, a peak waveform (“synthetic waveform”) consisting of the sum of the model functions which respectively correspond to those component peaks is created, and the process of fitting the synthetic waveform to the target peak is performed. Such a fitting process is repeated until the value of the degree of similarity falls within the predetermined range, to ultimately obtain an estimated number of component peaks included in the target peak and an inferred waveform of each component peak.

### CITATION LIST

### Patent Literature

Patent Literature 1: WO 2016/035167 A

### SUMMARY OF INVENTION

### Technical Problem

Since the number of component peaks included in the target peak is normally unknown, the previously described fitting process in the method disclosed in Patent Literature 1 initially assumes that the number of component peaks is one. Therefore, when a plurality of component peaks are included in the target peak, and if the number of peaks is considerably large, a considerable amount of time will be required until the estimated number of component peaks is obtained. Furthermore, in the previously described fitting process, the same number of model functions as the number of component peaks assumed to be included in the target peak are prepared, and the variables in each model function are adjusted. Each model function has a plurality of variables. For example, the BEMG function, which can express the tailing (the base portion that follows the peak) and the leading (the base portion that precedes the peak) of a peak waveform in a chromatogram, has five variables showing the position (retention time), height, width, extent of the tailing and extent of the leading of a peak. In the case of using the BEMG function as the model function, when the number of component peaks to be estimated is increased by one, the number of model functions will also be increased by one, with five more variables to be adjusted. The increase in the number of variables to be adjusted results in a longer period of time for the fitting process.

The problem to be solved by the present invention is to shorten the period of time required for separating peaks originating from a plurality of components overlapping each other on a chromatogram.

### Solution to Problem

A method for processing chromatogram data according to the present invention developed for solving the previously described problem includes:
a data preparation process for preparing first data including chromatogram data consisting of the retention time and the signal intensity of transmitted/absorbed light having a predetermined wavelength acquired by performing a chromatographic analysis for a sample containing a plurality of components, as well as second data which is three-dimensional data consisting of the retention time, the mass-to-charge ratio and the signal intensity acquired for the sample;
a target-peak-information acquisition process for acquiring information concerning a first retention-time range where a target peak is present and information concerning the waveform of the target peak, from a chromatogram created based on the first data;
a component-peak-information acquisition process for acquiring, as a measured component-peak number, the number of component peaks within a second retention-time range which corresponds to the first retention-time range in a three-dimensional graph created based on the second data;
a model function preparation process for preparing one or a plurality of model functions whose number equals the measured component-peak number, where each of the one or plurality of model functions involves a peak-width variable representing the peak width of a component peak;
a model modification process for modifying the one or plurality of model functions by adjusting the value of the peak-width variable in each of the one or plurality of model functions;
a similarity determination process for comparing the shape of the waveform of the target peak and the waveform of a model peak expressed by the one or plurality of model functions, to determine the degree of similarity between the model peak and the target peak; and
a completion determination process for determining that the modification of the one or plurality of model functions should be completed when the degree of similarity is equal to or higher than a threshold.

A system for processing chromatogram data according to the present invention developed for solving the previously described problem includes:
a data storage section configured to store first data including chromatogram data consisting of the retention time and the signal intensity of transmitted/absorbed light having a predetermined wavelength acquired by performing a chromatographic analysis for a sample containing a plurality of components, as well as second data which is three-dimensional data consisting of the retention time, the mass-to-charge ratio and the signal intensity acquired for the sample; and
a data-processing section configured to perform a computation using the first data and the second data stored in the data storage section,
where the data-processing section includes:
   a target-peak-information acquirer configured to acquire information concerning a first retention-time range where a target peak is present and information concerning the waveform of the target peak, from a chromatogram created based on the first data stored in the data storage section;
   a component-peak-information acquirer configured to acquire, as a measured component-peak number, the number of component peaks within a second retention-time range which corresponds to the first retention-time range in a three-dimensional graph created based on the second data stored in the data storage section;
   a model function preparer configured to prepare one or a plurality of model functions whose number equals the measured component-peak number, where each of the one or plurality of model functions involves a peak-width variable representing the peak width of a component peak;
   a model modifier configured to modify the one or plurality of model functions by adjusting the value of the peak-width variable in each of the one or plurality of model functions;
   a similarity determiner configured to compare the shape of the waveform of the target peak and the waveform of a model peak expressed by the one or plurality of model functions, to determine the degree of similarity between the model peak and the target peak; and
   a completion determiner configured to determine that the modification of the one or plurality of model functions should be completed when the degree of similarity is equal to or higher than a threshold.

### Advantageous Effects of Invention

In the method and system for processing chromatogram data according to the present invention, information concerning the first retention-time range where a target peak is present and information concerning the waveform shape of the target peak are acquired from a chromatogram created from chromatogram data included in the first data. Subsequently, the number of component peaks within the second retention-time range corresponding to the first retention-time range in a three-dimensional graph created based on the second data is acquired as a measured component-peak number. It can be considered that the number of component peaks acquired from the three-dimensional graph shows a value close to the number of component peaks actually included in the target peak. Accordingly, one or more model functions whose number equals the measured component-peak number which is the number of component peaks are prepared. Each model function involves, as a variable, a peak-width variable representing the peak width of a component peak. The value of the peak-width variable in each of the prepared one or more model functions is gradually varied, and the shape of the waveform of the model peak expressed by the one or more model functions is compared with that of the target peak to determine the degree of similarity between the model and the target peak. If the degree of similarity is equal to or higher than the threshold, it is concluded that the waveform of the model peak expressed by the one or more model functions approximates to the shape of the waveform of the target peak, and the process of modifying the model functions is completed. As compared to the conventional technique in which one or more model functions expressing the target peak are determined on the assumption that the number of component peaks included in the target peak is completely unknown, the present technique can efficiently determine the model function of the target peak and quickly separate peaks originating from a plurality of components overlapping each other in a chromatogram.

### BRIEF DESCRIPTION OF DRAWINGS

FIG. 1 is a block diagram schematically showing an embodiment of a data-processing system.

FIG. 2 is a flowchart for explaining an overall flow related to an initial-value setting process.

FIG. 3 is a flowchart for explaining an example of the procedure of the initial-value setting process.

FIG. 4 is a diagram for explaining an example of the procedure of the initial-value setting process.

FIG. 5 is a flowchart for explaining an example of the procedure of a model-function inferring process.

FIG. 6 is a diagram showing a display example of the peak separation result.

### DESCRIPTION OF EMBODIMENTS

An embodiment of the method and system for processing chromatogram data according to the present invention is hereinafter described with reference to the drawings.

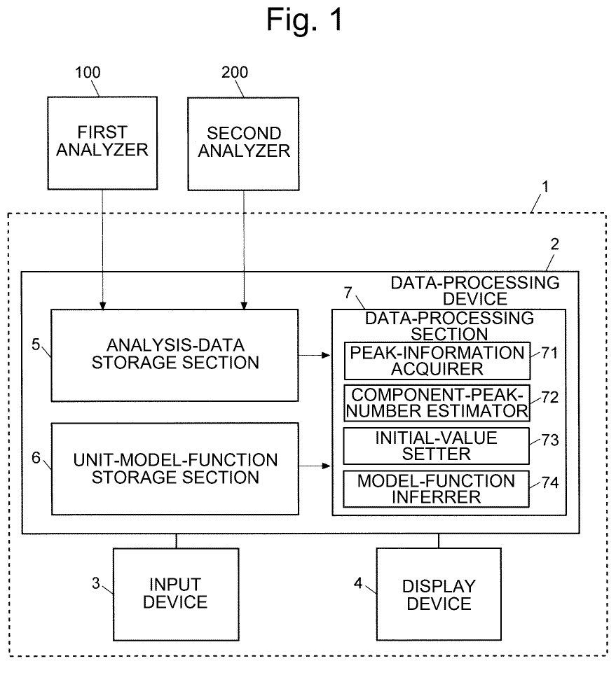

FIG. 1 shows one example of the system for processing chromatogram data.

The data-processing system 1 includes a data-processing device 2, input device 3 and display device 4. The data-processing device 2 is realized by a computer device such as a personal computer in which a dedicated program is introduced. The input device 3 is realized by a keyboard and/or mouse (or the like) connected to the data-processing device 2 via a data communication channel. Users can enter information into the data-processing device 2 through the input device 3. The display device 4 is connected to the data-processing device 2 via a data communication channel and displays information outputted from the data-processing device 2.

The data-processing device 2 includes an analysis-data storage section 5, unit-model-function storage section 6 and data-processing section 7. Two types of analysis data acquired with a first analyzer 100 and a second analyzer 200 are imported into the data-processing device 2. The first analyzer 100 is configured to perform a liquid chromatographic analysis for a sample using a PDA detector to acquire absorption spectra at regular intervals of time. In other words, the analysis data imported from the first analyzer 100 into the data-processing device 2 is three-dimensional data consisting of the retention time, wavelength and signal intensity of transmitted/absorbed light. The second analyzer 200 is configured to perform a liquid chromatographic analysis for a sample using a mass analyzer as the detector to acquire mass spectra at regular intervals of time. In other words, the analysis data imported from the second analyzer 200 into the data-processing device 2 is three-dimensional data consisting of the retention time, mass-to-charge ratio and signal intensity. In the following description, the three-dimensional data imported from the first analyzer 100 into the data-processing device 2 is called the “first data”, and the three-dimensional data imported from the second analyzer 200 into the data-processing device 2 is called the “second data”.

The analysis-data storage section 5 holds the first data imported from the first analyzer 100 and the second data imported from the second analyzer 200. First and second data acquired for the same sample are linked with each other and stored in the analysis-data storage section 5. The analysis-data storage section 5 can be realized by a non-volatile flash memory or hard disc drive (or the like). The analysis-data storage section 5 corresponds to the data storage section in the present invention.

The unit-model-function storage section 6 holds one or more unit model functions prepared beforehand. A unit model function is a model function expressing the waveform of a component peak in a three-dimensional graph having the three axes of retention time, wavelength and signal intensity acquired when a liquid chromatographic analysis using a PDA detector is performed for a sample containing one specific component (this graph may be hereinafter called the “three-dimensional chromatogram”). When a plurality of component peaks originating from a plurality of components are included in the target peak in the three-dimensional graph having the three axes of retention time, wavelength and signal intensity created based on the first data (i.e., when a plurality of components are contained in the sample), the model function for expressing the waveform of the target peak will be expressed by a “composite function” which is the sum of two or more unit model functions.

A unit model function can be expressed by the product of a function (matrix) expressing the waveform of a chromatogram having the two axes of retention time and signal intensity of light having a predetermined wavelength and a data (matrix) expressing the waveform of a spectrum having the two axes of wavelength and signal intensity of light. An example of the model function expressing the waveform of a chromatogram is the BEMG function. The BEMG function is a function configured to reproduce a peak waveform having tailing and leading portions similar to an actual peak waveform which emerges in a chromatogram. It consists of the combination of a Gaussian function and an exponential function. The unit model function involves a plurality of variables including the location (retention time) of a peak on a chromatogram and the waveform of a spectrum. For example, when the BEMG function is used as a function for expressing the waveform of a chromatogram, the unit model function will have variables including the retention time, height, width, extent of the tailing and extent of the leading of a peak as well as the waveform of a spectrum. The variables representing the retention time of the peak, width of the peak and waveform of the spectrum correspond to the retention-time variable, peak-width variable and spectrum-waveform variable in the present invention, respectively. As with the analysis-data storage section 5, the unit-model-function storage section 6 can be realized by a non-volatile flash memory or hard disk drive (or the like), although it can also be realized by a database located on a network.

The data-processing section 7 performs computations using the first and second data stored in the analysis-data storage section 5. The computations performed by the data-processing section 7 include a quantitative determination process for creating a chromatogram based on the first data and determining the concentration of a component contained in a sample from the area value of a peak on the chromatogram, as well as a peak separation process for separating a plurality of component peaks originating from components contained in a sample if those component peaks overlap each other on the chromatogram. The peak separation process is performed by the functions of the peak information acquirer 71, component-peak-number estimator 72, initial value setter 73 and model function inferrer 74 in the data-processing section 7.

The peak information acquirer 71 extracts the target peak as an analysis target from a three-dimensional graph created based on the first data and acquires information concerning the waveform of the target peak (the chromatogram waveform and spectrum waveform) and information concerning the range where the target peak is present (the retention-time range and wavelength range). The component-peak-number estimator 72 extracts a peak corresponding to a component peak which is most likely to be included in the target peak from the three-dimensional graph having the three axes of retention time, mass-to-charge ratio and signal intensity created based on the second data, and reads the retention time of each extracted peak.

Based on the number of peaks extracted by the component-peak-number estimator 72 and the retention time of each peak, the initial value setter 73 sets the initial values of the number of component peaks (the number of unit model functions; this number corresponds to the measured component-peak number which will be described later) and the retention time of each component peak (the retention-time variable in each unit model function) which are variables of a model function expressing the target peak. Based on the information concerning the waveform of the target peak acquired by the peak information acquirer 71 and the initial values set by the initial value setter 73, the model function inferrer 74 reads, from the unit-model-function storage section 6, unit model functions whose number equals the number of component peaks and creates a composite model function by adding those unit model functions. If the number of component peaks is one, the single unit model function itself serves as the composite model function. In the present embodiment, it is assumed that, when the number of component peaks is two or more, two or more identical unit model functions are read from the unit-model-function storage section 6 to create the composite model function. It is also possible to read different unit model functions to create the composite model function. The “retention time of each component peak” in the present example corresponds to the peak width of each component peak.

After creating the composite model function, the model function inferrer 74 performs the process of fitting the peak waveform expressed by the composite model function to the target peak while adjusting each variable in the composite model function, to determine a model function which expresses the waveform of the target peak. The functions of the data-processing section 7 are implemented by executing a program in a computer circuit having a CPU (central processing unit).

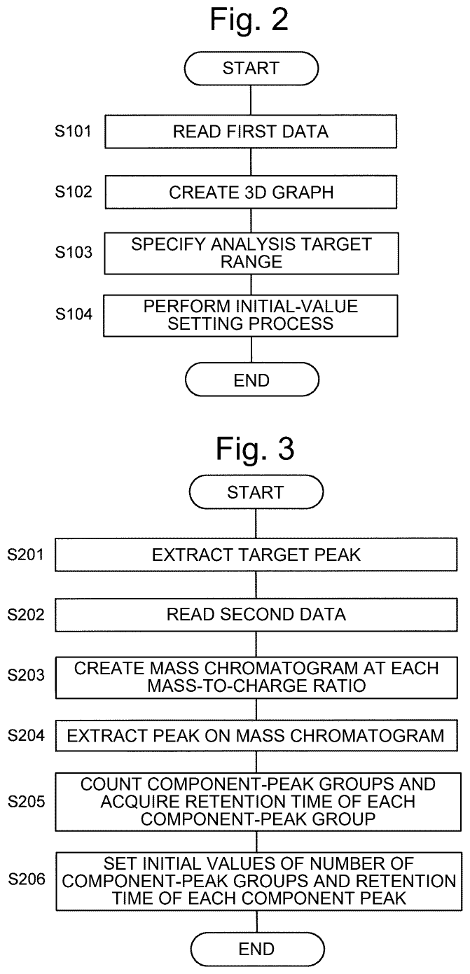

An overall flow related to an initial-value setting process is hereinafter described using the flowchart in FIG. 2.

Initially, a sample to be analyzed is designated by the user. Then, the data-processing section 7 reads the first data of the designated sample from the analysis-data storage section 5 (Step 101). The data-processing section 7 subsequently creates a three-dimensional graph from the read first data (“first three-dimensional graph”; Step 102) and shows the three-dimensional graph on the display device 4. Then, by an operation using the input device 3, the user specifies the retention-time range and the wavelength range of the analysis target on the first three-dimensional graph shown on the display device 4 (Step 103), and issues a command to perform the initial-value setting process, whereupon the data-processing section 7 performs the initial-value setting process (Step 104).

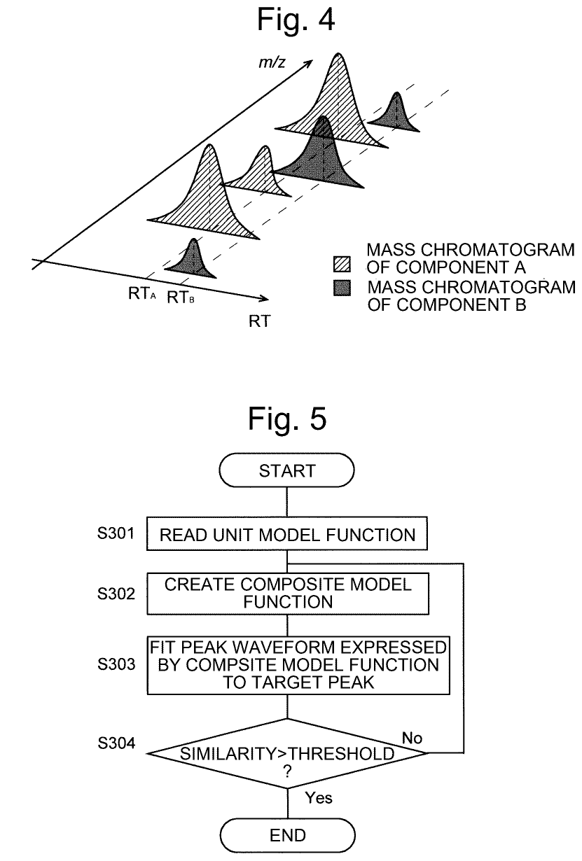

The procedure of the initial-value setting process is hereinafter described using the flowchart in FIG. 3 and the diagram in FIG. 4.

When the initial-value setting process has been initiated, the peak information acquirer 71 extracts, from the first three-dimensional graph created in Step 102, a target peak which is the portion of the graph located within the retention-time range of the designated analysis target and acquires information concerning the waveform of the target peak (chromatogram waveform and spectrum waveform) and information concerning the retention-time range of the analysis target (Step 201). The retention-time range of the analysis target corresponds to the first retention-time range in the present invention. Accordingly, the retention-time range of the analysis target is hereinafter called the first retention-time range. At this point, it is unknown whether the target peak consists of a single component peak or a plurality of component peaks.

Subsequently, the component-peak-number estimator 72 reads the second data of the sample to be analyzed from the analysis-data storage section 5 (Step 202) and creates, from the second data, a three-dimensional graph (“second three-dimensional graph”) including a mass chromatogram showing the temporal change of the signal intensity at each mass-to-charge ratio and a mass spectrum showing the relationship between the signal intensity and the mass-to-charge ratio (Step 203). In this second three-dimensional graph, the component-peak-number estimator 72 focuses on spectra at predetermined retention times located within a retention-time range corresponding to the first retention-time range (“second retention-time range”), extracts peaks from each spectrum, and counts those peaks (Step 204). For the present case, it is assumed that each peak having an intensity equal to or higher than a predetermined intensity value should be extracted. The first and second retention-time ranges may be the same range, or a temporal shift may be provided between the first and second retention-time ranges considering the configuration of the device (the capacity of and the flow velocity within the tube through which a sample flows).

For example, FIG. 4 shows that spectra (not shown) at retention times RT_{A} and RT_{B} in the second three-dimensional graph have been focused on and three peaks have been extracted from each spectrum.

If the number of peaks extracted from the spectrum at a retention time exceeds a predetermined number (e.g., 3-5 peaks), the component-peak-number estimator 72 concludes that a component peak is present at that retention time, and relates that retention time to the component peak and saves those pieces of information (Step 205). After the determination on the presence or absence of a component peak has been completed for all retention times, the component-peak-number estimator 72 counts the number of retention times at which it was concluded that a component peak was present within the second retention-time range. This number is saved as a measured component-peak number along with the retention times at which it was concluded that a component peak was present. If a retention time at which it was concluded that a component peak was present is temporally close to another retention time at which it had already been concluded that a component peak was present, it may possibly mean that the same component peak was redundantly extracted from different spectra, and therefore, the component peak at one of the two retention times does not need to be included in the measured component-peak number.

Subsequently, the initial value setter 73 sets the measured component-peak number obtained in Step 205 as the number of component peaks which is a variable in the model function expressing the waveform of the target peak and also sets the retention time of each component peak as the initial value of the retention-time variable in the model function (unit model function) for that component peak (Step 206).

In the example shown in FIG. 4, component peak A consisting of three peaks and originating from component A contained in the sample has been extracted at retention time RT_{A} within the second retention-time range, while component peak B consisting of three peaks and originating from component B contained in the sample has been extracted at retention time RT_{B}. In this example, the initial value of the number of component peaks in the model function expressing the waveform of the target peak is set to “2”, and the initial values of the retention-time variables in the unit model functions for the component peaks originating from components A and B are set to RT_{A} and RT_{B}, respectively.

After the completion of the initial-value setting process, the process of inferring the model function is subsequently performed. The procedure for the process of inferring the model function is hereinafter described using the flowchart in FIG. 5.

Based on the information concerning the waveform of the target peak obtained in Step 201 and the initial value of the number of component peaks set in Step 206, the model function inferrer 74 reads, from the unit model function storage section 6, unit model functions whose number equals the number of component peaks (Step 301). Then, the model function inferrer 74 substitutes the initial value of the retention time of each component peak set in Step 206 into each of the read unit model functions. As regards the other variables in the unit model functions, random numbers are set as their respective initial values. By adding the thus obtained unit model functions, the model function inferrer 74 creates a composite model function (Step 302). After that, the model function inferrer 74 fits the peak waveform expressed by the composite model function to the target peak, adjusting each variable in the composite model function (Step 303).

For the fitting process in Step 303, commonly known methods can be used. One example is the method disclosed in Patent Literature 1. In the method disclosed in Patent Literature 1, the model function expressing the waveform of the target peak is determined by a calculation using the least squares method. Specifically, a degree of similarity is determined which evaluates the degree to which the shape of the waveform of the peak expressed by the model function approximates to the shape of the actual waveform of the target peak, and whether or not the degree of similarity exceeds a threshold is determined (Step 304). If the degree of similarity does not exceed the threshold (“No” in Step 304), the operation returns to Step 303 to once more perform the fitting of the peak waveform expressed by the composite model function to the target peak after modifying the variables in the composite model function.

The “variables in the composite model function” means variables in each of the added unit model functions, including: a height variable which represents the height of the component peak, a peak-width variable which represents the width of the component peak, a retention-time variable which represents the retention time of the component peak, and a spectrum-waveform variable which represents the shape of the component peak in the spectrum direction. Accordingly, the fitting process in Step 303 includes modifying the variables in all unit model functions, adding the modified unit model functions to obtain a composite model function, and comparing the shape of the peak expressed by the composite model function with that of the target peak to determine the degree of similarity. If the value of the degree of similarity does not exceed the threshold even after the adjustment of the variables in the composite model function, it is concluded that the number of component peaks is insufficient, and one more unit model function is added to create a composite model function and perform the fitting process in Step 303. The initial values of the variables in the unit model function to be added are set to random values. The model function inferrer 74 repeats the fitting process in Step 303 until the value of the degree of similarity exceeds the predetermined threshold. When the value of the degree of similarity has exceeded the predetermined threshold (“Yes” in Step 304), the model function inferrer 74 discontinues the fitting process, concluding that the peak waveform expressed by the composite model function approximates to the waveform of the target peak.

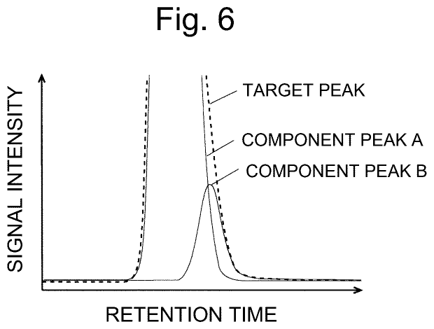

Through the processing described thus far, the number of component peaks included in the target peak and the waveform of each component peak (chromatogram waveform and spectrum waveform) can be inferred, and the plurality of component peaks overlapping each other on the target peak in the chromatogram can be separated from each other. The result of the separation of the component peaks is shown on the display device 4. FIG. 6 shows a display example of the result of the separation of the component peaks.

### Modified Examples

In the previously described embodiment, the measured component-peak number obtained in Step 205 was directly set as the initial value of the number of component peaks which is a variable in the model function. It is also possible to set, as the initial value, a value which is smaller than the measured component-peak number by a predetermined number. Although the measured component-peak number is highly likely to be the number of component peaks included in the target peak, it is possible that the measured component-peak number be larger than the number of component peaks actually included in the target peak. Since the model-function inferring process makes the composite model function gradually approximate to the actual target peak while increasing the number of component peaks from the initial value, it may be impossible to estimate the correct number of component peaks if the initial value of the number of component peaks is set to be larger than the actual number. Accordingly, when the measured component-peak number equals or larger than two, a value which is smaller than that number by one may be set as the initial value of the number of component peaks in the model function. This setting can prevent the situation in which the correct number of component peaks cannot be estimated when the measured component-peak number is one peak larger than the number of component peaks actually included in the target peaks.

In the previously described embodiment, both the chromatogram waveform and the spectrum waveform were inferred for each component peak included in the target peak on the three-dimensional graph created based on the first data. Alternatively, only a chromatogram waveform may be inferred for each component peak included in a target peak on a chromatogram (two-dimensional chromatogram) created based on the retention time and the signal intensity of the light having a predetermined wavelength (chromatogram data) included in the first data. In this case, the unit model function is expressed by a function which shows the peak waveform of a chromatogram.

### [Modes]

It is evident to a person skilled in the art that the previously described illustrative embodiment is a specific example of the following modes of the present invention.

(Clause 1) A method for processing chromatogram data according to one mode of the present invention includes:
a data preparation process for preparing first data including chromatogram data consisting of the retention time and the signal intensity of transmitted/absorbed light having a predetermined wavelength acquired by performing a chromatographic analysis for a sample containing a plurality of components, as well as second data which is three-dimensional data consisting of the retention time, the mass-to-charge ratio and the signal intensity acquired for the sample;
a target-peak-information acquisition process for acquiring information concerning a first retention-time range where a target peak is present and information concerning the waveform of the target peak, from a chromatogram created based on the first data;
a component-peak-information acquisition process for acquiring, as a measured component-peak number, the number of component peaks within a second retention-time range which corresponds to the first retention-time range in a three-dimensional graph created based on the second data;
a model function preparation process for preparing one or a plurality of model functions whose number equals the measured component-peak number, where each of the one or plurality of model functions involves a peak-width variable representing the peak width of a component peak;
a model modification process for modifying the one or plurality of model functions by adjusting the value of the peak-width variable in the one or plurality of model functions;
a similarity determination process for comparing the shape of the waveform of the target peak and the waveform of a model peak expressed by the one or plurality of model functions, to determine the degree of similarity between the model peak and the target peak; and
a completion determination process for determining that the modification of the one or plurality of model functions should be completed when the degree of similarity is equal to or higher than a threshold.

(Clause 6) A system for processing chromatogram data according to one mode of the present invention includes:
a data storage section configured to store first data including chromatogram data consisting of the retention time and the signal intensity of transmitted/absorbed light having a predetermined wavelength acquired by performing a chromatographic analysis for a sample containing a plurality of components, as well as second data which is three-dimensional data consisting of the retention time, the mass-to-charge ratio and the signal intensity acquired for the sample; and
a data-processing section configured to perform a computation using the first data and the second data stored in the data storage section,
where the data-processing section includes:
   a target-peak-information acquirer configured to acquire information concerning a first retention-time range where a target peak is present and information concerning the waveform of the target peak, from a chromatogram created based on the first data stored in the data storage section;
   a component-peak-information acquirer configured to acquire, as a measured component-peak number, the number of component peaks within a second retention-time range which corresponds to the first retention-time range in a three-dimensional graph created based on the second data stored in the data storage section;
   a model function preparer configured to prepare one or a plurality of model functions whose number equals the measured component-peak number, where each of the one or plurality of model functions involves a peak-width variable representing the peak width of a component peak;
   a model modifier configured to modify the one or plurality of model functions by adjusting the value of the peak-width variable in the one or plurality of model functions;
   a similarity determiner configured to compare the shape of the waveform of the target peak and the waveform of a model peak expressed by the one or plurality of model functions, to determine the degree of similarity between the model peak and the target peak; and
   a completion determiner configured to determine that the modification of the one or plurality of model functions should be completed when the degree of similarity is equal to or higher than a threshold.

As compared to the conventional technique in which one or more model functions expressing the target peak is determined on the assumption that the number of component peaks included in the target peak and the retention time of each component peak are completely unknown, the method for processing chromatogram data according to Clause 1 and the system for processing chromatogram data according to Clause 6 can efficiently determine the model function of the target peak and quickly separate peaks respectively originating from a plurality of components overlapping each other on a chromatogram.

In the process of fitting the peak waveform, if there are many variables involved in the one or plurality of model functions, the model will have a statistically high degree of freedom, which may prevent successful estimation of the variables and cause the data-processing computation to be unstable. In the method for processing chromatogram data according to Clause 1 and the system for processing chromatogram data according to Clause 6, since the process of fitting the peak waveform is performed from a state in which initial values having a certain degree of accuracy are given, the estimation accuracy of the number of component peaks as well as the shape of each component peak and its magnitude (and other features) will be improved. The period of time for the estimation can also be shortened since the period of time for estimating the number of models can be reduced.

(Clause 2) In the method for processing chromatogram data according to Clause 2, which is a method for processing chromatogram data according to Clause 1,
the model function further involves a retention-time variable representing the retention time of a component peak,
the component-peak-information acquisition process includes acquiring a measured component retention time representing the retention time of each component peak, and the method further includes an initial-value setting process for setting the measured component retention time as the retention-time variable.

(Clause 7) In the system for processing chromatogram data according to Clause 7, which is a system for processing chromatogram data according to Clause 6,
the model function further involves a retention-time variable representing the retention time of a component peak,
the component-peak-information acquirer is configured to acquire a measured component retention time representing the retention time of each component peak, and
the data-processing section further includes an initial value setter configured to set the measured component retention time as the retention-time variable.

In the method for processing chromatogram data according to Clause 2 and the system for processing chromatogram data according to Clause 7, the number of component peaks included in the target peak and the retention time of each component peak are roughly estimated and the obtained values are used as the initial values for the related variables in the one or plurality of model functions expressing the target peak. Therefore, the one or plurality of model functions of the target peak can be even more efficiently determined as compared to the conventional technique in which one or more model functions expressing the target peak are determined on the assumption that the number of component peaks and the retention time of each component peak are completely unknown.

(Clause 3) In the method for processing chromatogram data according to Clause 3, which is a method for processing chromatogram data according to Clause 1 or 2, the component-peak-information acquisition process includes concluding that a single component peak is present at a predetermined retention time within the retention-time range in the three-dimensional graph created based on the second data when the number of peaks exceeding a predetermined threshold at the predetermined retention time is equal to or greater than a predetermined number.

(Clause 8) In the system for processing chromatogram data according to Clause 8, which is a system for processing chromatogram data according to Clause 6 or 7, the component-peak-information acquirer is configured to conclude that a single component peak is present at a predetermined retention time within the retention-time range in the three-dimensional graph created based on the second data when the number of peaks exceeding a predetermined threshold at the predetermined retention time is equal to or greater than a predetermined number.

If the estimated number of component peaks included in the target peak is larger than the actual number, the model function expressing the target peak may not be correctly determined, or a considerable amount of time may be required for the process of inferring the model function. The method for processing chromatogram data according to Clause 3 and the system for processing chromatogram data according to Clause 8 can lower the probability that an incorrect model function is inferred.

(Clause 4) In the method for processing chromatogram data according to Clause 4, which is a method for processing chromatogram data according to one of Clauses 1-3,
the first data includes spectrum data consisting of the signal intensity and the wavelength of transmitted/absorbed light,
the target peak is a three-dimensional peak extracted from a three-dimensional chromatogram created from the first data,
the one or plurality of model functions further involve a spectrum-waveform variable concerning the waveform of a spectrum, and
the model modification process includes adjusting the spectrum-waveform variable.

(Clause 9) In the system for processing chromatogram data according to Clause 9, which is a system for processing chromatogram data according to one of Clauses 6-8,
the first data includes spectrum data consisting of the signal intensity and the wavelength of transmitted/absorbed light,
the target peak is a three-dimensional peak extracted from a three-dimensional chromatogram created from the first data,
the one or plurality of model functions further involve a spectrum-waveform variable concerning the waveform of a spectrum, and
the model modifier is configured to adjust the spectrum-waveform variable.

In the method for processing chromatogram data according to Clause 4 and the system for processing chromatogram data according to Clause 9, the first data is three-dimensional data which includes chromatogram data consisting of the retention time and the signal intensity of the transmitted/absorbed light as well as spectrum data consisting of the signal intensity and the wavelength of the transmitted/absorbed light. A three-dimensional chromatogram means a three-dimensional graph created based on this three-dimensional data.

By the method for processing chromatogram data according to Clause 4 and the system for processing chromatogram data according to Clause 9, component peaks originating from a plurality of components can be separated from each other not only on a chromatogram but also on a spectrum.

(Clause 5) In the method for processing chromatogram data according to Clause 5, which is a method for processing chromatogram data according to one of Clauses 1-4, the one or plurality of model functions include a function consisting of a combination of a Gaussian function and an exponential function.

(Clause 10) In the system for processing chromatogram data according to Clause 10, which is a system for processing chromatogram data according to one of Clauses 6-9, the one or plurality of model functions include a function consisting of a combination of a Gaussian function and an exponential function.

In the method for processing chromatogram data according to Clause 5 and the system for processing chromatogram data according to Clause 10, the peak waveform of the actual peak can be accurately reproduced by the aforementioned model function, so that the estimation accuracy of the component peak will be improved.

### REFERENCE SIGNS LIST

1 . . . . Data-Processing System
2 . . . . Data-Processing Device
3 . . . . Input Device
4 . . . . Display Device
5 . . . . Analysis-Data Storage Section
6 . . . . Unit-Model-Function Storage Section
7 . . . . Data-Processing Section
71 . . . Peak-Information Acquirer
72 . . . Component-Peak-Number Estimator
73 . . . . Initial-Value Setter
74 . . . Model-Function Inferrer
100 . . . . First Analyzer
200 . . . . Second Analyzer

1. A method for processing chromatogram data, comprising:
a data preparation process for preparing first data including chromatogram data consisting of a retention time and a signal intensity of transmitted/absorbed light having a predetermined wavelength acquired by performing a chromatographic analysis for a sample containing a plurality of components, as well as second data which is three-dimensional data consisting of a retention time, a mass-to-charge ratio and a signal intensity acquired for the sample;
a target-peak-information acquisition process for acquiring information concerning a first retention-time range where a target peak is present and information concerning a waveform of the target peak, from a chromatogram created based on the first data;
a component-peak-information acquisition process for acquiring, as a measured component-peak number, a number of component peaks within a second retention-time range which corresponds to the first retention-time range in a three-dimensional graph created based on the second data;
a model function preparation process for preparing one or a plurality of model functions whose number equals the measured component-peak number, where each of the one or plurality of model functions involves a peak-width variable representing a peak width of a component peak;
a model modification process for modifying the one or plurality of model functions by adjusting a value of the peak-width variable in the one or plurality of model functions;
a similarity determination process for comparing a shape of the waveform of the target peak and a waveform of a model peak expressed by the one or plurality of model functions, to determine a degree of similarity between the model peak and the target peak; and
a completion determination process for determining that a modification of the one or plurality of model functions should be completed when the degree of similarity is equal to or higher than a threshold.

2. The method for processing chromatogram data according to claim 1, wherein:
the one or plurality of model functions further involve a retention-time variable representing a retention time of a component peak;
the component-peak-information acquisition process includes acquiring a measured component retention time representing the retention time of each component peak; and
the method further includes an initial-value setting process for setting the measured component retention time as the retention-time variable.

3. The method for processing chromatogram data according to claim 1, wherein the component-peak-information acquisition process includes concluding that a single component peak is present at a predetermined retention time within the second retention-time range in the three-dimensional graph created based on the second data when a number of peaks exceeding a predetermined threshold at the predetermined retention time is equal to or greater than a predetermined number.

4. The method for processing chromatogram data according to claim 1, wherein:
the first data includes spectrum data consisting of a signal intensity and a wavelength of transmitted/absorbed light;
the target peak is a three-dimensional peak extracted from a three-dimensional chromatogram created from the first data;
the one or plurality of model functions further involve a spectrum-waveform variable concerning a waveform of a spectrum; and
the model modification process includes adjusting the spectrum-waveform variable.

5. The method for processing chromatogram data according to claim 1, wherein the one or plurality of model functions include a function consisting of a combination of a Gaussian function and an exponential function.

6. A system for processing chromatogram data, comprising:
a data storage section configured to store first data including chromatogram data consisting of a retention time and a signal intensity of transmitted/absorbed light having a predetermined wavelength acquired by performing a chromatographic analysis for a sample containing a plurality of components, as well as second data which is three-dimensional data consisting of a retention time, a mass-to-charge ratio and a signal intensity acquired for the sample; and
a data-processing section configured to perform a computation using the first data and the second data stored in the data storage section,
where the data-processing section includes:
a target-peak-information acquirer configured to acquire information concerning a first retention-time range where a target peak is present and information concerning a waveform of the target peak, from a chromatogram created based on the first data stored in the data storage section;
a component-peak-information acquirer configured to acquire, as a measured component-peak number, a number of component peaks within a second retention-time range which corresponds to the first retention-time range in a three-dimensional graph created based on the second data stored in the data storage section;
a model function preparer configured to prepare one or a plurality of model functions whose number equals the measured component-peak number, where each of the one or plurality of model functions involves a peak-width variable representing a peak width of a component peak;
a model modifier configured to modify the one or plurality of model functions by adjusting a value of the peak-width variable in the one or plurality of model functions;
a similarity determiner configured to compare a shape of the waveform of the target peak and a waveform of a model peak expressed by the one or plurality of model functions, to determine the degree of similarity between the model peak and the target peak; and
a completion determiner configured to determine that a modification of the one or plurality of model functions should be completed when the degree of similarity is equal to or higher than a threshold.

7. The system for processing chromatogram data according to claim 6, wherein:
the one or plurality of model functions further involve a retention-time variable representing a retention time of a component peak;
the component-peak-information acquirer is configured to acquire a measured component retention time representing a retention time of each component peak; and
the data-processing section further includes an initial value setter configured to set the measured component retention time as the retention-time variable.

8. The system for processing chromatogram data according to claim 6, wherein the component-peak-information acquirer is configured to conclude that a single component peak is present at a predetermined retention time within the retention-time range in the three-dimensional graph created based on the second data when a number of peaks exceeding a predetermined threshold at the predetermined retention time is equal to or greater than a predetermined number.

9. The system for processing chromatogram data according to claim 6, wherein:
the first data includes spectrum data consisting of a signal intensity and a wavelength of transmitted/absorbed light;
the target peak is a three-dimensional peak extracted from a three-dimensional chromatogram created from the first data;
the one or plurality of model functions further involve a spectrum-waveform variable concerning the waveform of a spectrum; and
the model modifier is configured to adjust the spectrum-waveform variable.

10. The system for processing chromatogram data according to claim 6, wherein the one or plurality of model functions include a function consisting of a combination of a Gaussian function and an exponential function.
